(19) United States
(12) Patent Application Publication
(10) Pub. No.: US 2008/0303693 A1
(43) Pub. Date: Dec. 11, 2008

(54) Methods and Systems for Automated Traffic Reporting

(76) Inventor: Charles M. Link, II, Atlanta, GA (US)

Correspondence Address: Ballard Spahr Andrews & Ingersoll, LLP, SUITE 1000, 999 PEACHTREE STREET, ATLANTA, GA, 30309-3915, US

(21) Appl. No.: 11/759,739

(22) Filed: Jun. 7, 2007

(51) Int. Cl. G08G 99/00; G06G 7/76

(52) U.S. Cl. 340/905; 701/117; 701/119

(57) ABSTRACT

An automatic traffic reporting system comprising a vehicle mounted data transceiver (telematics device) and centrally operated information collectors and analyzers that generate real time traffic reports for selected areas of interest.

### BACKGROUND

Automobile traffic collection and disbursement of information for wide geographic areas involves a variety of sensors, technologies and methods. In some locales, traffic is collected in a low-tech fashion by using observers on the ground or in the air to relay opinions about the state of traffic flow. Higher tech ways of collecting traffic involve positioning live video camera in strategic locations to relay traffic flow information back to central analysts who characterize traffic flow. More automated and more high-tech methods involve using roadway sensors or RF transponders to capture flow information and relay this flow information to central analysts. A major problem area for media outlets is to rapidly generate a uniform traffic information product that covers an entire geographic area of interest, perhaps the entire United States and even in select international regions. Based on current collection methods, it becomes a disjointed and labor intensive process to assemble a uniform traffic model that can be distributed nationwide covering all the major areas of interest.

Large scale compilation of traffic data into a manageable product that can be easily and quickly disseminated is a daunting task. By its nature, traffic conditions are fluid and constantly changing. One accident on major traffic artery can almost immediately affect feeders and alternates. With the various current collection methods and their human components, rapid condition updates for a large metropolitan area is impossible.

### SUMMARY

In another embodiment, provided are methods for automated traffic reporting comprising dividing a geographic region into a plurality of polygons, receiving traffic data associated with at least one of the plurality of polygons wherein the traffic data is generated according to a reporting parameter, collecting the received traffic data, and transmitting the collected traffic data associated with the at least one of the plurality of polygons to a user located within the at least one of the plurality of polygons.

In another embodiment, provided are methods for automated traffic reporting comprising determining a location of a user, the location having an associated polygon, transmitting a request for traffic data corresponding to the associated polygon, receiving the traffic data associated with the polygon, wherein the traffic data is generated according to a reporting parameter, and providing the traffic data to the user.

In a further embodiment, provided are methods for automated traffic reporting comprising determining a location of a user, transmitting traffic data along with the location of the user, wherein the traffic data is generated according to a reporting parameter, receiving the traffic data along with the location of the user, determining a polygon associated with the user location, and updating a database of traffic data associated with the polygon with the received traffic data.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive as claimed.

### BRIEF DESCRIPTION OF THE DRAWINGS

The accompanying drawings, which are incorporated in and constitute a part of this specification, illustrate embodiments and together with the description, serve to explain the principles of the methods and systems disclosed:

FIG. 1 is a block diagram of an embodiment of a “vehicle telematics unit and traffic probe” (VTUTP);

FIG. 2 illustrates an example map containing polygons comprised of road segments of interest;

FIG. 3 is an exemplary logic flow diagram showing an overall flow of messages from “central traffic assimilating center” (CTAC) to VTUTP and back to CTAC;

FIG. 4 is an exemplary logic flow diagram showing internal processing methodology within a VTUTP;

FIG. 5 shows an exemplary grid location and the associated naming convention;

FIG. 6 is an exemplary Kalman filter input versus output showing the processing step to stabilize the location of the vehicle using a WAAS equipped GPS;

FIG. 7 illustrates an exemplary method for automated traffic reporting;

FIG. 8 illustrates another exemplary method for automated traffic reporting; and

FIG. 9 illustrates yet another exemplary method for automated traffic reporting.

### DETAILED DESCRIPTION

Before the present methods and systems are disclosed and described, it is to be understood that the disclosed methods and systems are not limited to specific synthetic methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Disclosed embodiments may be understood more readily by reference to the following detailed description and the Examples included therein and to the Figures and their previous and following description.

The methods and systems described herein generally relate to telematics devices, central data collectors and related services and, more particularly, to methods and systems that can selectively and/or automatically forwards useful traffic flow information for analysis and/or disbursement.

### I. General

To effectively capture traffic data, a system with a plurality of probes can be deployed. The more probes, the more accurate the traffic data will be. A solution can be to deploy as many probes in as many places as possible. Anywhere there are cars in any concentration, there can be probes. If the exact location of each vehicle were known (e.g. vehicle is on interstate not on access road), if the exact status (e.g. rider is in a car versus in a train) were known, and if the exact speed for that vehicle were known, then the traffic data would be perfect. Using automatic data processing methods to assimilate and report the traffic data, without human subjectivity would be a major step towards a perfect system. Even if a small subset of the vehicles on the road communicated traffic data regularly, the traffic data would be more accurate than the information generally available today.

Disclosed are methods and systems that can deliver the required flexibility, accuracy and economy as required for a nationwide traffic collection system. The methods and systems described herein can merge the available resources of a cellular data network along with the one way Satellite Digital Audio Receiver System (SDARS) or other satellite bulk data distribution capability along with a telematic device to deliver a very accurate traffic map. The methods and systems can utilize equipment that is placed in a vehicle for entirely different purposes and provide desired traffic data as required for delivering accurate traffic reports.

Today, vehicles are equipped with a variety of safety, information and entertainment devices. Almost every vehicle manufactured today contains some type of radio receiver for entertainment. Though all of those receivers contain capability to receive AM and FM broadcasts on the standard frequencies used for that purposes, many now contain SDARS receivers that receive digital data streams containing many audio entertainment and digital information streams. The typical SDARS receiver in the U.S. can receive about 12 million bits per second which may or may not be wholly broadcast from a high power satellite. Depending on the exact system and network engineering, some portion of the SDARS bandwidth may be received from terrestrial stations to offer better signal coverage and building penetration in the urban canyons of the typical metropolitan city. Though not currently allowed under the existing SDARS licensing structure, some portion of the content can contain locally generated programming or data.

Among the safety devices occasionally installed in certain passenger vehicles are wireless communication and location determining devices that can be used to report crashes and other roadway emergencies as well as concierge services. These devices, also commonly referred to as “telematics” boxes generally contain a wireless communications device such as a cellular or PCS communications device, a global positioning system (“GPS”) and in many cases accelerometers for automatic crash detection. Upon detection of a crash, or activation of a user pushbutton, the telematics box can initiate a wireless call or digital message to an operator who can notify the local public safety access point (“PSAP”) to the event as well as the address or map location of the event. This functionality is well known and established within the automotive industry. It is a popular option that is included on several automobile manufacturers' vehicles.

Among the information devices, some vehicles contain computer generated road maps providing the driver with accurate travel directions. Enhancements to the onboard computer system allow the mapping subsystem to display current traffic status overlaid on the computer generated map to allow the driver to make intelligent trip decisions. In most metro areas with traffic, many times a driver only learns about the traffic at the time he encounters it. The use of SDARS to distribute traffic information quickly to subscribers allows drivers to make real time intelligent decisions regarding travel routes.

Among the entertainment devices, some vehicles can be equipped with video displays capable of displaying video content contained on storage such as flash drives, hard drives, compact disks (CDs), digital video disks (DVDs), and the like, audio equipment capable of playing audio content contained on storage such as flash drives, hard drives, compact disks (CDs), digital video disks (DVDs), and the like.

Video content can comprise movies, television shows, commercials, and the like, in formats such as DVD, Blueray, HD-DVD, MPG, AVI, WMA, and the like. Audio content can comprise music, commercials, podcasts, radio shows, audio books and the like, in formats such as WAV, WMA, MP3, and the like. Audio and video content can be implemented with controls for digital rights management.

Provided are methods and systems for combining the safety, information, and entertainment devices to provide an accurate traffic reporting environment. Utilizing the synergies of a GPS, a display screen, a wireless phone, and an entertainment system, an “infotainment” system can be created. This infotainment system has the capability for building a traffic receiving system using SDARS (or another satellite-based system) or FM sub-carrier for data carriage.

The usefulness of the traffic system depends on the accurate and timely collection of traffic status along with the objective and uniform presentation of traffic data. An exemplary solution to traffic collection is to have each vehicle periodically report speed and location and have a central server place the vehicle on a virtual map where it is correlated with other received data and used to generate a composite traffic report. This solution, however, is not cost effective. An alternate solution is to have the vehicle selectively report in real time based on certain reporting parameters. This solution allows a traffic manager to define the conditions that will cause a vehicle to report. An exemplary method can be to pre-load the mapping database with minimum speeds and report exceptions to the minimum speeds. Another example can be to examine the braking activity of a driver and report traffic conditions based on excessive braking application by the driver.

### II. Exemplary Apparatus

In one aspect, provided is an apparatus comprising a telematics control unit.

The apparatus can be installed in a vehicle. Such vehicles include, but are not limited to, personal and commercial automobiles, motorcycles, transport vehicles, watercraft, aircraft, and the like. For example, an entire fleet of a vehicle manufacturer's vehicles can be equipped with the apparatus. The apparatus 101, also referred to herein as the VTUTP 101, can operate as a traffic probe. In this function, a plurality of VTUTPs 101 can be deployed to ensure useful traffic information is captured. For example, hundreds, thousands, millions, and the like can be deployed.

All components of the telematics unit can be contained within a single box and controlled with a single core processing subsystem or can be comprised of components distributed throughout a vehicle. Each of the components of the apparatus can be separate subsystems of the vehicle, for example, a communications component such as a SDARS, or other satellite receiver, can be coupled with an entertainment system of the vehicle.

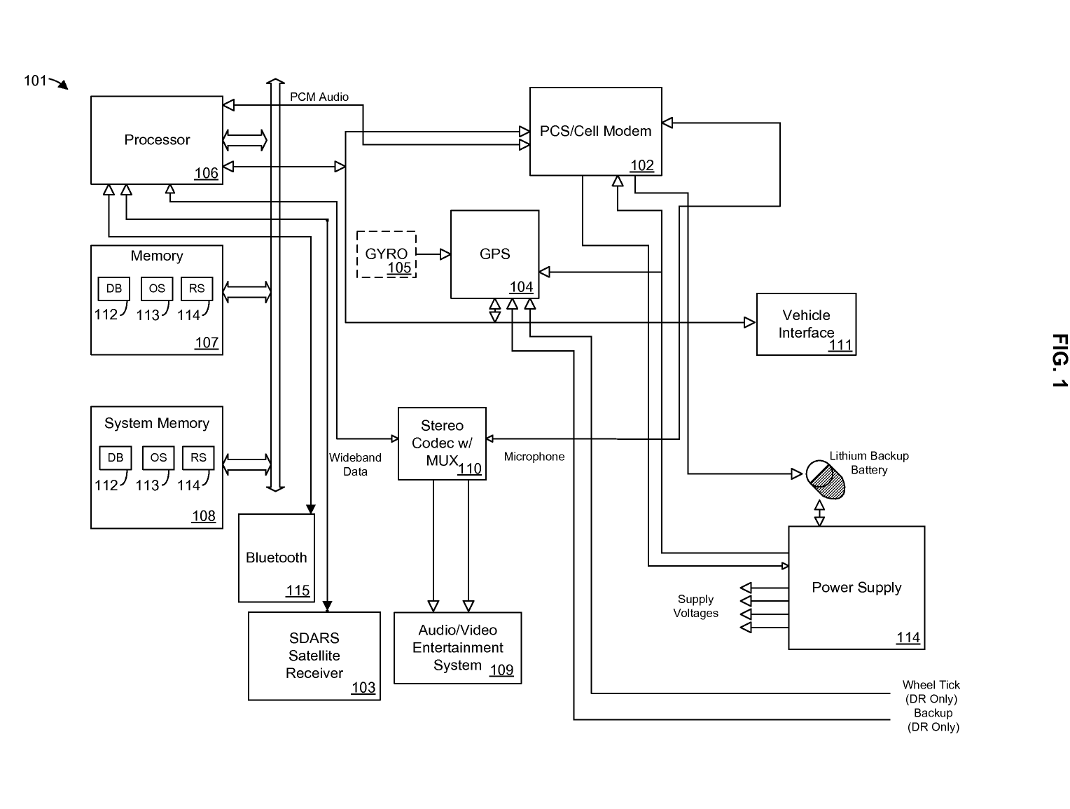

An exemplary apparatus 101 is illustrated in FIG. 1. This exemplary apparatus is only an example of an apparatus and is not intended to suggest any limitation as to the scope of use or functionality of operating architecture. Neither should the apparatus be necessarily interpreted as having any dependency or requirement relating to any one or combination of components illustrated in the exemplary apparatus. The apparatus 101 can comprise one or more communications components. Apparatus 101 illustrates communications components (modules) PCS/Cell Modem 102 and SDARS receiver 103. These components can be referred to as vehicle mounted transceivers when located in a vehicle. PCS/Cell Modem 102 can operate on any frequency available in the country of operation, including, but not limited to, the 850/1900 MHz cellular and PCS frequency allocations. The type of communications can include, but is not limited to GPRS, EDGE, UMTS, 1xRTT or EV-DO. The PCS/Cell Modem 102 can be a Wi-Fi or mobile WIMAX implementation that can support operation on both licensed and unlicensed wireless frequencies. The apparatus 101 can comprise an SDARS receiver 103 or other satellite receiver. SDARS receiver 103 can utilize high powered satellites operating at, for example, 2.35 GHz to broadcast digital content to automobiles and some terrestrial receivers, generally demodulated for audio content, but can contain digital data streams.

PCS/Cell Modem 102 and SDARS receiver 103 can be used to update an onboard database 112 contained within the apparatus 101. Updating can be requested by the apparatus 101, or updating can occur automatically. For example, database updates can be performed using FM subcarrier, cellular data download, other satellite technologies, Wi-Fi and the like. SDARS data downloads can provide the most flexibility and lowest cost by pulling digital data from an existing receiver that exists for entertainment purposes. An SDARS data stream is not a channelized implementation (like AM or FM radio) but a broadband implementation that provides a single data stream that is separated into useful and applicable components. Entertainment data can be extracted from the SDARS data stream at the same time as traffic area of interest database updates.

GPS receiver 104 can receive position information from a constellation of satellites operated by the U.S. Department of Defense. Alternately, the GPS receiver 104 can be a GLONASS receiver operated by the Russian Federation Ministry of Defense, or any other positioning device capable of providing accurate location information (for example, LORAN, inertial navigation, and the like). GPS receiver 104 can contain additional logic, either software, hardware or both to receive the Wide Area Augmentation System (WAAS) signals, operated by the Federal Aviation Administration, to correct dithering errors and provide the most accurate location possible. Overall accuracy of the positioning equipment subsystem containing WAAS is generally in the two meter range. Optionally, the apparatus 101 can comprise a MEMS gyro 105 for measuring angular rates and wheel tick inputs for determining the exact position based on dead-reckoning techniques. This functionality is useful for determining accurate locations in metropolitan urban canyons, heavily tree-lined streets and tunnels.

One or more processors 106 can control the various components of the apparatus 101. Processor 106 can be coupled to removable/non-removable, volatile/non-volatile computer storage media. By way of example, FIG. 1 illustrates memory 107, coupled to the processor 106, which can provide non-volatile storage of computer code, computer readable instructions, data structures, program modules, and other data for the computer 101. For example and not meant to be limiting, memory 107 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

The processing of the disclosed systems and methods can be performed by software components. The disclosed system and method can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed method can also be practiced in grid-based and distributed computing environments where tasks are performed by remote processing devices that are linked through a communications network. In a distributed computing environment, program modules can be located in both local and remote computer storage media including memory storage devices.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

Any number of program modules can be stored on the memory 107, including by way of example, an operating system 113 and reporting software 114. Each of the operating system 113 and reporting software 114 (or some combination thereof) can comprise elements of the programming and the reporting software 114. Data can also be stored on the memory 107 in database 112. Database 112 can be any of one or more databases known in the art. Examples of such databases comprise, DB2®, Microsoft® Access, Microsoft® SQL Server, Oracle®, mySQL, PostgreSQL, and the like. The database 112 can be centralized or distributed across multiple systems.

By way of example, the operating system 113 can be a Linux (Unix-like) operating system. One feature of Linux is that it includes a set of “C” programming language functions referred to as “NDBM”. NDBM is an API for maintaining key/content pairs in a database which allows for quick access to relatively static information. NDBM functions use a simple hashing function to allow a programmer to store keys and data in data tables and rapidly retrieve them based upon the assigned key. A major consideration for an NDBM database is that it only stores simple data elements (bytes) and requires unique keys to address each entry in the database. NDBM functions provide a solution that is among the fastest and most scalable for small processors.

It is recognized that such programs and components reside at various times in different storage components of the apparatus 101, and are executed by the processor 106 of the apparatus 101. An implementation of reporting software 114 can be stored on or transmitted across some form of computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

FIG. 1 illustrates system memory 108, coupled to the processor 106, which can comprise computer readable media in the form of volatile memory, such as random access memory (RAM, SDRAM, and the like), and/or non-volatile memory, such as read only memory (ROM). The system memory 108 typically contains data and/or program modules such as operating system 113 and reporting software 114 that are immediately accessible to and/or are presently operated on by the processor 106. The operating system 113 can comprise a specialized task dispatcher, slicing available bandwidth among the necessary tasks at hand, including communications management, position determination and management, entertainment radio management, SDARS data demodulation and assessment, power control, and vehicle communications.

The processor 106 can control additional components within the apparatus 101 to allow for ease of integration into vehicle systems. The processor 106 can control power to the components within the apparatus 101, for example, shutting off GPS receiver 104 and SDARS receiver 103 when the vehicle is inactive, and alternately shutting off the PCS/Cell Modem 102 to conserve the vehicle battery when the vehicle is stationary for long periods of inactivity. The processor 106 can also control an audio/video entertainment subsystem 109 and comprise a stereo codec and multiplexer 110 for providing entertainment audio and video to the vehicle occupants, for providing wireless communications audio (PCS/Cell phone audio), speech recognition from the driver compartment for manipulating the SDARS receiver 103 and PCS/Cell Modem 102 phone dialing, and text to speech and pre-recorded audio for vehicle status annunciation.

The apparatus 101 can interface and monitor various vehicle systems and sensors to determine vehicle conditions. Apparatus 101 can interface with a vehicle through a vehicle interface 111. The vehicle interface 111 can include, but is not limited to, OBD (On Board Diagnostics) port, OBD-II port, CAN (Controller Area Network) port, and the like. The vehicle interface 111, allows the apparatus 101 to receive data indicative of vehicle performance, such as vehicle trouble codes, operating temperatures, operating pressures, speed, fuel air mixtures, oil quality, oil and coolant temperatures, wiper and light usage, mileage, break pad conditions, and any data obtained from any discrete sensor that contributes to the operation of the vehicle engine and drive-train computer. Additionally CAN interfacing can eliminate individual dedicated inputs to determine brake usage, backup status, and it can allow reading of onboard sensors in certain vehicle stability control modules providing gyro outputs, steering wheel position, accelerometer forces and the like for determining driving characteristics. The apparatus 101 can interface directly with a vehicle subsystem or a sensor, such as an accelerometer, gyroscope, airbag deployment computer, and the like.

Communication with a vehicle driver can be through an infotainment (radio) head (not shown) or other display device (not shown). More than one display device can be used. Examples of display devices include, but are not limited to, a monitor, an LCD (Liquid Crystal Display), a projector, and the like.

The apparatus 101 can receive power from power supply 114. The power supply can have many unique features necessary for correct operation within the automotive environment. One mode is to supple a small amount of power (typically less than 100 microamps) to at least one master controller that can control all the other power buses inside of the VTUTP 101. In an exemplary system, a low power low dropout linear regulator supplies this power to PCS/Cellular modem 102. This provides the static power to maintain internal functions so that it can await external user push-button inputs or await CAN activity via vehicle interface 111. Upon receipt of an external stimulus via either a manual push button or CAN activity, the processor contained within the PCS/Cellular modem 102 can control the power supply 114 to activate other functions within the VTUTP 101, such as GPS 104/GYRO 105, Processor 106/Memory 107 and 108, SDARS receiver 103, audio/video entertainment system 109, audio codec mux 110, and any other peripheral within the VTUTP 101 that does not require standby power.

In an exemplary system, there can be a plurality of power supply states. One state can be a state of full power and operation, selected when the vehicle is operating. Another state can be a full power relying on battery backup. It can be desirable to turn off the GPS and any other non-communication related subsystem while operating on the back-up batteries. Another state can be when the vehicle has been shut off recently, perhaps within the last 30 days, and the system maintains communications with a two-way wireless network for various auxiliary services like remote door unlocking and location determination messages. After the recent shut down period, it is desirable to conserve the vehicle battery by turning off almost all power except the absolute minimum in order to maintain system time of day clocks and other functions, waiting to be awakened on CAN activity. Additional power states are contemplated, such as a low power wakeup to check for network messages, but these are nonessential features to the operation of the VTUTP.

Normal operation can comprise, for example, the PCS/Cellular modem 102 waiting for an emergency pushbutton key-press or CAN activity. Once either is detected, the PCS/Cellular modem 102 can awaken and enable the power supply 114 as required. Shutdown can be similar wherein a first level shutdown turns off everything except the PCS/Cellular modem 102, for example. The PCS/Cellular modem 102 can maintain wireless network contact during this state of operation. The VTUTP 101 can operate normally in the state when the vehicle is turned off. If the vehicle is off for an extended period of time, perhaps over a vacation etc., the PCS/Cellular modem 102 can be dropped to a very low power state where it no longer maintains contact with the wireless network.

Additionally, in FIG. 1, subsystems can include a BlueTooth transceiver 115 provided to interface with occupant supplied devices such as phones, headsets, and music players.

### III. Traffic Reporting

### A. Polygons

A polygon is a closed plane figure made up of several line segments that are joined together. The sides do not cross each other. Exactly two sides can meet at every vertex. Every polygon can have at least three line segments or more. Polygons can be used because of the mathematical relationships that allow a point to be described as “inside” a polygon or “outside” of a polygon. Furthermore, polygons can be convenient for describing areas that may contain complex road segments. Traditional mapping methods describe a road as a vector and the condition of “on the road” or “off the road” is described as a measurement from the vector. A polygon contains at least one traffic area of interest.

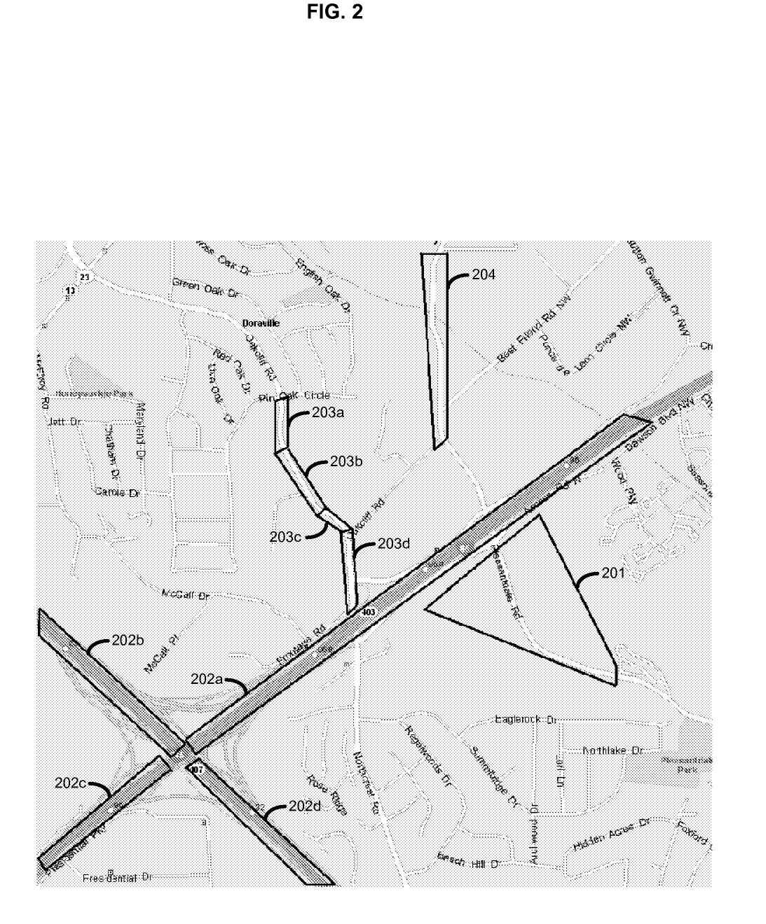

Traffic areas of interest can be characterized and mapped with road segments of interest. Traffic areas of interest can be, for example, a subdivision, or political division or any other geographical area that can be described and contained within a polygon. A traffic area of interest can be, for example, a shopping center parking lot, a neighborhood, an intersection, and the like. Road segments of interest can be, for example, a single roadway, either one-way or two-way, excluding access roads, entrance or exit ramps or other nearby pavement where a vehicle may sometimes travel. A road segment of interest can be, for example, a long winding road through a rural area or a small straight segment through dense urban areas. A road segment of interest can be divided into directional lanes or one road segment can contain both directions of travel. Each of these road segments of interest can be broken into a polygon, for example, a four point polygon (squares, rectangles and trapezoids). A polygon can comprise one or more road segments of interest. FIG. 2 provides examples of polygons containing traffic areas of interest. Polygon 201 comprises a neighborhood, polygons 202a-d each comprise a portion of an interstate highway, polygons 203a-d each comprise a section of the same road, and polygon 204 comprises a long stretch of rural road.

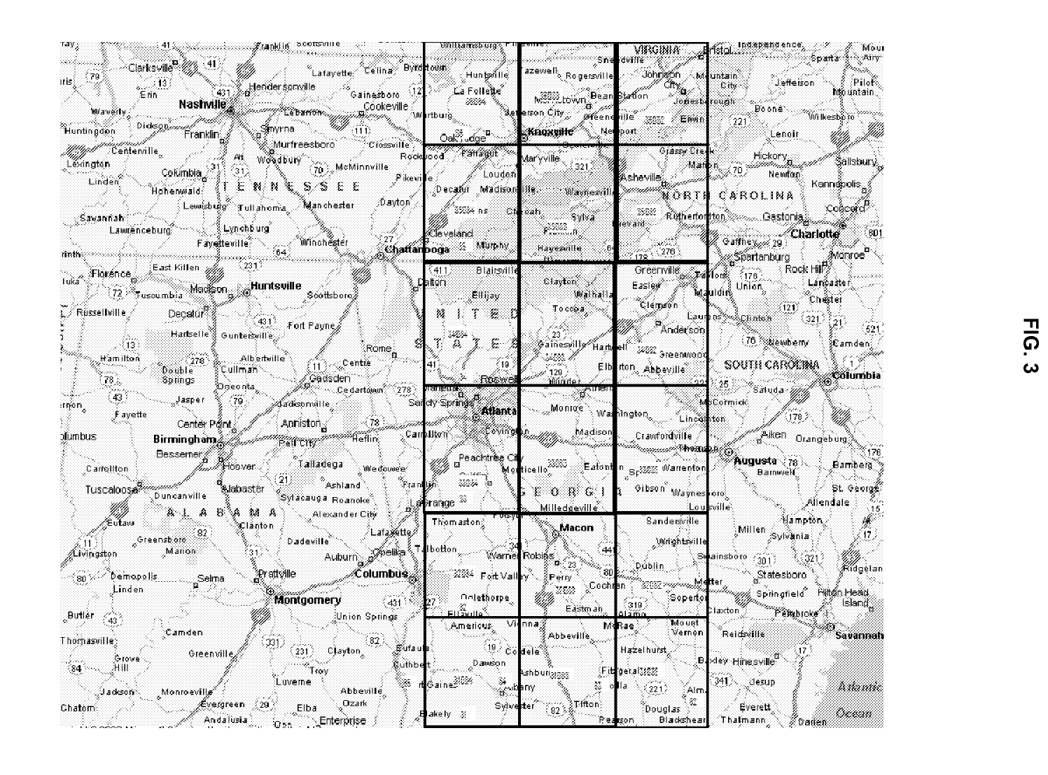

Each VTUTP 101 can receive nationwide, or partial downloads of polygon databases based on database size and a traffic area of interest. In an exemplary system, the continental U.S. can be divided into grid squares of 1 degree latitude by 1 degree longitude. Each grid square then measures approximately 70×50 miles, as shown in FIG. 3. Each VTUTP 101 can receive, from a Central Traffic Condition Assimilation Center (CTCAC), also referred to as a Central Traffic Assimilating Center (CTAC), via a SDARS broadcast, one or more polygon databases, each grid square having an associated polygon database. A polygon database can comprise data associated with one or more polygons in the grid square. The VTUTP 101 can determine the latitude and longitude of the vehicle in which the VTUTP 101 is installed via the GPS. The VTUTP 101 can then determine the grid square containing the vehicle's location, and all surrounding grid squares, four grid squares one each from the north, south, east, and west, and four grid squares, one each from the northeast, southeast, southwest, and northwest. By way of example, nine polygon databases can be received, representing polygon data from the nine grid squares.

Having determined the desired grid squares, the VTUTP 101 can load the nine applicable grid squares and their associated polygons from the polygon databases. Each of these polygons can comprise one or more traffic areas of interest for a traffic reporting system. Recognizing that vehicles are not static and move about, the VTUTP 101 can update a “home” location once per interval. An interval can be user definable. An interval can be, for example, 21 days, allowing a user to travel outside of his home area for a vacation. However, if the vacation stretches to more than three weeks, the VTUTP 101 can download a new set of applicable grids and their associated polygons. In the case of a vehicle traveling out of its normal home location, since it does not have a valid database for the new area, it can be configured to refrain from reporting traffic until three weeks (or other predefined period) have elapsed. This prevents the VTUTP 101 from constantly updating the polygon database. A special exception algorithm can cause the VTUTP 101 to retrieve the new database after three days instead of three weeks for a new deployment. This exception algorithm can operate by determining the previous usage history (for example, the number of days of active usage recorded in a historic file) or similar method that can automatically retrieve the polygon database if no other is present or if the vehicle has been inactive for some extended period of time. In either case, the vehicle would not necessarily retrieve a new database by virtue of traveling to a new destination and remaining there for a short period of time.

### B. Reporting Parameters

The VTUTP 101 can merge received polygon databases into a single active searchable database, for example, database 112. The searchable database can comprise as many polygons as the region has traffic areas of interest. Each polygon can have associated reporting parameters described in the database. Reporting parameters can be thresholds, times, or any other factor that affects when and/or if vehicle data is transmitted from the VTUTP 101 to a central processing station. Reporting parameters can comprise a related minimum speed, amount of braking usage, a random response factor, and the like, for each of a set of specific times per day. For example, a day can be divided into four time brackets, 6 AM to 10 AM, 10 AM to 3 PM, 3 PM to 7 PM and 7 PM to 7 AM. The day can be divided into any number of time periods or brackets, with accuracy/applicably being traded off with data storage space on the VTUTP 101 and download time. Each polygon time bracket can comprise a minimum speed that the vehicle must significantly travel below or other exception condition based on any parameter available to the VTUTP 101 over the CAN bus before it is considered an exception. In an exemplary system, the time that the vehicle is below the minimum speed can be a threshold to allow short excursions from the minimum speed set as a parameter in the database, and it allows traffic reporting for roads with stop lights. The minimum time can be a factor in the polygon database along with the other factors. The minimum time factor can be a fixed time, for example, 30 seconds.

Another example of a reporting parameter can be a driver's application of brakes. If a driver is traveling on an interstate for example, he would not normally be applying his brakes, whereas if the driver is traveling on a busy interchange with many traffic lights, he would spend most of the time with his foot on the brake. This reporting factor can be set to any value between 0 and 100 percent.

Another example of a reporting factor can be a random response factor. When a VTUTP system is initially deployed, its managers could want all VTUTP units to report traffic exceptions. After several million are deployed and a single polygon might have several VTUTP equipped vehicles traveling through the polygon at any given instant, the random response factor might be reduced to cause the VTUTP to report the exception only perhaps ten percent of the time based on a pseudo random generation algorithm.

### C. Traffic Attributes

Traffic attributes are additional parameters that cause the vehicle to report an exception condition. For example, pressure of braking applied by driver, outside air temperature, precipitation monitors, wiper usage, light usage, fog lamp usage, defroster usage, cruise control usage, vehicle stability control module information (for example, a determination that the road slippery). The reporting parameters described in the previous section are generally events considered with respect to time, while traffic attributes are considered without regard to a time factor. Traffic attributes apply to the polygon containing the road segment traveled.

### D. Exceptions

Exceptions are conditions where the vehicle conditions are observed to be outside of the “normal” state as defined by the parameters in polygon database for a specific defined polygon in the database where the vehicle currently is located.

If a parameter is breached, an exception can be generated. For example, if a vehicle must have a speed less than a minimum speed for a consecutive period of time specified by a time factor and the vehicle travels less than that speed for that period of time, with the vehicle in a forward gear as determined via a vehicle interface query, an exception can be generated. This allows for a vehicle to be traveling on a heavy thoroughfare and perhaps pull off for gas, which would reset the sequence. Once the vehicle re-enters the thoroughfare, a timer can restart. In another example, comparisons to speed and percentage of braking can be used as reporting parameters. The percentage of braking allows normal stop and go traffic on a thoroughfare that contains stop lights. For example, speed exceptions can be allowed for consecutive times one second less than the time factor in a segment before reporting an exception. Braking exceptions can be based on a percentage of the time factor. If the time factor was set to sixty seconds, and the braking factor was set at 50%, the driver would be allowed thirty seconds of continuous braking before an exception is generated. Interstates can have low braking factors and side roads can have high braking factors.

An exception report can be created that reflects one or more of the generated exceptions. A message containing the exception report can be forwarded to a traffic collection management system. The exception report can comprise the polygon number, vehicle location, and vehicle speed. This information can be de-identified to remove any “privacy” issues that a vehicle occupant might experience. The VTUTP can be configured to not report speeds higher than normal and can be configured to only report exceptions to the reporting parameters retrieved from the searchable database, alleviating excessive traffic reports and wasted communications costs.

A CTCAC can receive traffic updates from the vehicles equipped with VTUTPs in the form of the exception reports. Due to well defined reporting parameters and traffic attributes downloaded to a vehicle, only traffic exceptions are normally generated. This can work well, but if a road is closed a mechanism is required to report that condition. This is provided herein for periodic “good” traffic reporting. Communications bandwidth should not be wasted by all vehicles reporting on every segment they traveled if traffic is flowing perfectly. Further, communications bandwidth should not be wasted if a vehicle is traveling in a remote rural area with no traffic conditions of interest to the traffic system managers. If a vehicle is traveling perhaps thirty miles every day and traveling through fifty polygons, this vehicle can potentially be a reporter of good traffic conditions.

Every vehicle can record details of a trip from start to completion. As a vehicle travels through polygons, the VTUTP can record the average speed through the polygons as well as the polygon identifiers. A random response factor can be assigned to each polygon and the random response factor controls whether the vehicle shall report at the end of a normal trip. When the vehicle reaches its destination, the VTUTP can average the polygon response factor values for the polygons traveled and generate a pseudo random number to determine if it should report the trip traffic for the route just completed. In the exemplary system, perhaps the vehicle travels through five different segments, with a response factor of 10, 20, 30, 50 and 70 for each of the segments respectively. Those response factors average to 36. If the VTUTP generates a random number less than 36 (in a range from 1 to 100), then the VTUTP will provide a trip report for the entire trip. If the VTUTP determines that a trip report is to be made, then a report can be uploaded to the CTCAC that includes all polygon identifiers and average speeds through the polygons traveled. The trip report can be a report that is generated some period of time after an event may have occurred, but it can also provide positive feedback to the traffic system managers that thoroughfares are operating smoothly. If a particular polygon is of interest to a traffic manager, they can increase the response factor and lower the minimum speed to receive more frequent updates on that polygon and correct for the more frequent reports.

Reports to the CTCAC can be based on specific polygons. A polygon can be comprised of multiple roads and interchanges or perhaps an entire city. The CTCAC can map traffic reports back to actual roadways using the coordinates reported by the exception report. It may be that a polygon contains both a high speed freeway and a low speed access road. That situation can cause a report from a vehicle traveling on the low speed access road if the conditions are mapped for the high speed freeway. This provides condition information for access roads as well, and can be eliminated in reports to media if they are not interested in the access road. Further, the vehicle reports can be eliminated by removing the access road from the polygon in question.

### E. CTCAC

The CTCAC or Central Traffic Condition Assimilation Center is a centrally accessible computing center that can rapidly receive and process traffic reports from vehicles equipped with VTUTP units. The CTCAC can be a single computing platform or it can be multiple platforms that simultaneously receive numerous traffic condition reports, determine traffic conditions for based on multiple reports from multiple polygons, perhaps from multiple vehicles and subsequently report traffic assessment reports based on those reports and automated calculations. In the exemplary system, a single CTCAC is described, but it is contemplated to have a CTCAC in regional areas, grid squares or states having a CTCAC performing calculations independently for the defined area.

The CTCAC in an exemplary system contains a report receiving subsystem that is the central depository for all the traffic reports generated by the vehicles containing VTUTP units. This subsystem receives the report, and decodes the report into useful manageable data from the compressed format that is sent over the network. This report contains the grid square ID and segment ID and the receiving subsystem subsequently forwards the data to a processing system that will process the area specific information.

The area specific subsystem contains a database of every polygon that is loaded in the VTUTP database. This database has the parameters that trigger events as well as attributes that may apply to the polygon. For example, the triggering parameter may be speed less than 50 MPH, but a temperature and/or precipitation attribute may have triggered the report. The report is decoded to assign the reason for the report and some vehicles may be reporting rain (those vehicles equipped with precipitation detectors) while others may be reporting speeds under the minimum threshold. This information is assimilated by the CTCAC and forwarded to a traffic condition reporting subsystem.

### IV. Database Organization

Searchable database organization can be a factor in efficient apparatus operation. The polygon databases can be designed before they are downloaded into the VTUTP. Based on a 1×1 degree grid square model, the continental U.S. is comprised of approximately 938 grid squares. Each grid square can be assigned the name of its vertices as its name so the grid square is easily identified for any lookup. As an example, the grid square containing some portion of Atlanta, Ga. with a specified location of N33.76050 W084.39288 has the vertices N33.0 W084.0, N34.0 W084.0, N33.0 W085.0, and N34.0 W085.0. The grid square can be named by the full corners of its vertices. Since 1 degree grids were used, and each grid square starts on an even degree boundary, the grid square can be named by the single coordinate of the most southern and most eastern vertex. Therefore, the grid square can be referred to as “33084”. This grid square covers an area of approximately 70×50 miles (depending on latitude). FIG. 3 shows an exemplary grid location and the associated name. Since a vehicle could reside and normally pass though one or more of its boundaries, the VTUTP can also download and utilize one or more of the adjacent grid square polygon databases. Adjacent grid squares are easily identified via a simple algorithm. Assuming x=33 and y=084, the algorithm is x−1|y, x+1|y, x−1|y−1, x|y−1, x+1|y−1, x−1|y+1, x|y+1, x+1|y+1 where “|” denotes concatenate. The adjacent grid squares for this location are 32084, 34084, 32083, 33083, 34083, 32085, 33085, and 34085.

The VTUTP can monitor an SDAS datastream until one or more of the nine polygon databases named above are received. Each polygon database can be downloaded, stored and tagged by date by the VTUTP.

A polygon database for a grid square can comprise data for one or more polygons within the grid square at three different levels. For the most rural areas of the country, there may be no polygons or a minimum number of polygons contained within the grid square. In the case where no polygons are of interest to the managers, the downloaded database shall be empty, but date tagged for update and tracking purposes. In cases where there are a limited number of polygons, perhaps spanning a very large area, those polygons are presented and addressed directly in the database.

Grid squares can be broken down into sub-grid squares, herein referred to as “quartergrids,” “superquads,” and “quads.” Each grid square can comprise four quartergrids, 100 superquads, or 400 quads. A grid square can be divided by a tenth of a degree and also identified by the southeast corner. A superquad database entry containing the aforementioned GPS location with tenth of a degree granularity can be identified as 3370843. Since the superquad is divided to tenth of a degree increment, it is approximately 7 by 5 miles. In the most urban areas, where many roads are of interest, a superquad can further be divided by four, dividing the grid square by 400, or 1/20 of a degree. This provides polygon database entries the most direct unit of search, a quad, which is 3.5×2.5 miles. The quad can be identified again by its most southeastern corner, 337508435. One consideration for breaking down a grid square is the fact that a polygon can be defined in each of the quads, superquads or quartergrids if the polygon has a presence in more than one grid, quartergrid, superquad, or quad.

Even though the searchable database created by the one or more polygon databases associated with one or more grid squares is a single database, a unique data addressing scheme is provided to increase efficiency. For example, a vehicle is located in a very dense, and traffic sensitive urban area called Alpha City. The home location of this vehicle is N044.65432 W 15.73321. The urban area is ten miles by ten miles and is directly in the center of the grid 44115. This grid contains many polygons and has polygon database entries broken down into polygons addressed by quads. As one travels north of Alpha City, there is only one road. That road is an interstate that runs straight through 45115. It is of interest to the traffic collectors so polygons containing that road are within the searchable database. Directly to the northeast is desert area containing no roads of interest to the traffic collectors. That grid has a name of 46114.

Table 1 shows an excerpt from an example of a subset of this exemplary searchable database. The table contains notes marked “(n)” where n is from 1-10. Explanations of these notes are found below the table. The data not shown include minimum speed, braking, reporting factor and time factor for the remaining time periods of a day. V1-V4 indicate the four vertices of a polygon.

| | | | | | | | | 6 AM to 10 AM | | | |
|---|---|---|---|---|---|---|---|---|---|---|---|
| Name | | Detail | Polygon | | | | | Min | | Rep | Time |
| Key | Date | Flag | ID | V1 | V2 | V3 | V4 | Speed | Braking | Factor | Factor |
| 044aa115aa | ##### | 0 | | (1) | | | | | | | |
| 044aa115aa | ##### | 0 | | (2) | | | | | | | |
| 044aa115aa | ##### | 0 | | | | | | | | | |
| 044aa115aa | ##### | 0 | | | | | | | | | |
| 044aa115aa | ##### | 0 | | (3) | | | | | | | |
| 0440a1150a | ##### | 1 | | (4) | | | | | | | |
| 0440011500 | ##### | 2 | | (5) | | | | | | | |
| 0445511570 | ##### | 0 | 5555 | (6) | | | | | | | |
| | | | 5678 | | | | | | | | |
| 0445511570 | ##### | 0 | 5555 | Lat/ | Lat/ | Lat/ | Lat/ | 25 | 5 | 100 | 20 |
| | | | 5679 | Lon | Lon | Lon | Lon | | | | |
| 0445511570 | ##### | 0 | 5555 | Lat/ | Lat/ | Lat/ | Lat/ | 45 | 5 | 10 | 40 |
| | | | 5680 | Lon | Lon | Lon | Lon | | | | |
| 044aa116aa | ##### | 5 | | (7) | | | | | | | |
| 044aa116aa | ##### | 6 | | (8) | | | | | | | |
| 044aa116aa | ##### | 0 | 0 | (9) | | | | | | | |
| 033aa084aa | ##### | | | (10) | | | | | | | |
| 0338a0845a | ##### | | | | | | | | | | |

(1) This is the first record of a grid square that is not subdivided. Note “aa” is invalid character and is indicator of grid.
(2) The detail flag “0” indicates this is a “grid square” entry.
(3) This record has an invalid number. Only “offsets” from 0-999 are valid. Each entry contains a key (in each case they match) and an offset, ranging from 0-999. A NDBM key is unique by combining key + offset.
(4) This record indicates the grid is broken into 100 smaller units called superquads. Note the “a” character. Searches are done on the 1/10 degree increment. The 1 indicates that the lookup is a superquad lookup.
(5) This record indicates a quad, stepped a 1/20 degree increments. This is the finest granularity. Searches can be rounded to the lower 1/20 degree increment. The two indicates that the lookup is a quad lookup.
(6) This is the first record of a quad polygon entry. All entries for this quad have an increasing offset. The database can be “traversed” for subsequent searches until the offset “aaa” is discovered. “aaa” can be the termination of polgyons in a database.
(7) Note the “5”. This record indicates that this grid is divided into superquads.
(8) Note the “6”. This record indicates that this grid is divided into quads.
(9) All Grids in a specific database can have at least one entry. This entry shows the date and a Polygon ID of “00000000” indicating no entries of interest in the grid.
(10) This is a first record for a polygon in a grid square. The first entry can have an offset “000”.

The entry 0445511570 is a polygon entry configured to reports exactly the same time around the clock (columns indicating remaining times of the day not shown). A vehicle would report 100% of the time if the speed was below 25 MPH 20% of the time in the polygon or if the driver had his foot on the brake more than 5 percent of the time in the polygon. The entry 0445511570 is a polygon entry that has different profiles depending on the time of day (columns indicating remaining times of the day not shown). The entry has a minimum speed of 45 MPH in the morning, 55 MPH during lunch, 45 in the evening, and 65 in the midnight hours. It also reflects more cars on the route during the morning and afternoon drive times and subsequently less chance of reporting based on a random number generation and check.

Each grid NDBM record can be tagged with a 5 byte key (or index). The index is formed by taking the first three digits (the degrees) of the latitude and longitude as shown, and combining them with a hexadecimal digit “A.” This is done because the “A” is never going to appear in a full address and this provides the uniqueness required by the NDBM database. If the vehicle is parked in the home driveway and the VTUTP is attempting to determine if the vehicle is in a targeted polygon, the first step is to determine if the vehicle is present in a quad. The VTUTP can generate a trial key (lookup key) for the quad:

| Latitude | Rounded down | Longitude | Rounded down | |
|---|---|---|---|---|
| degrees | Latitude | degrees | Longitude | Key |
| 044.65432 | 04465 | 115.73321 | 11570 | 0446511570 |

Lookup results based on this key concatenated with “000” (the first record of the sequence) yield no results, indicating that no polygons exist on a quad level. Note that the rounded latitude is the next lower 0.05 degree increment. The key value must reference the quad address based on the addressing previously established. If used to physically address a grid with 1/20^{th} of degree accuracy, this point is the southern most and eastern most vertex of the grid.

The VTUTP can then search to see if a superquad record exists. The VTUTP can assemble a key based on the superquad format:

| Latitude | Rounded down | Longitude | Rounded down | |
|---|---|---|---|---|
| degrees | Latitude | degrees | Longitude | Key |
| 044.65432 | 0446 | 115.73321 | 1157 | 0446a1157a |

This record can be established with the four digits of each of the latitude and longitude with an “a” appended to the four digits and the two concatenated together. This allows a lookup of a point in the database if the polygons were established on a superquad level. The search can start with the smallest increment of area, the quad and move to a grid square search. This allows a grid square to contain records that may be addressed as smaller polygons and as larger polygons that may traverse multiple quads or superquads.

Each time a search is conducted, it can be conducted with the beginning polygon of each element. The beginning polygon can be labeled “000.” The last search can be at the grid square level and the record can be assembled as shown:

| Latitude degrees | Filler | Longitude degrees | Filler | Key |
|---|---|---|---|---|
| 044 | Aa | 115 | Aa | 044aa115aa |

Based on the key generated concatenated with “000” (the first record of the sequence) [the actual NDBM key is “044aa115aa000”], the VTUTP addresses the searchable database and reads a “0” record. This “0” is the first actual polygon contained within this grid square. This record contains four vertex points to a polygon. The location can be tested against the polygon to determine if the point resides within the polygon. If the point does reside within the polygon, then the polygon identifier and polygon vertices are locally stored as well as reporting parameters and traffic attributes which are retrieved for comparison to current conditions.

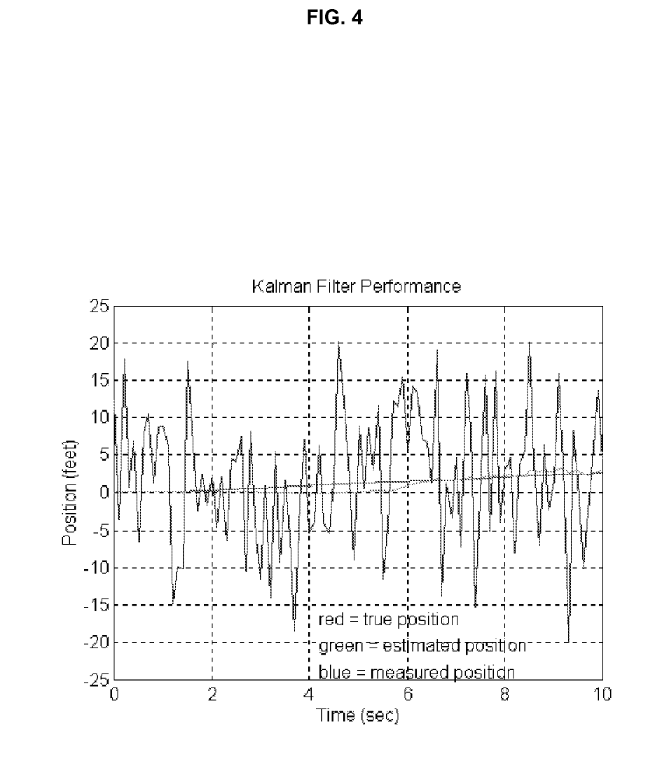

The GPS can resolve a vehicle position once per second and filter the position with a Kalman filtering algorithm, known to those skilled in the art and with outputs shown in FIG. 4. Each subsequent searchable database search can test the location against the current polygon to determine if the VTUTP remains within that polygon. If a position is found to be outside of the polygon previously located, the VTUTP can begin the task of searching for a polygon match, and progresses on each subsequent location update to attempt to locate a polygon match.

### IV. Exemplary Methods of Operation

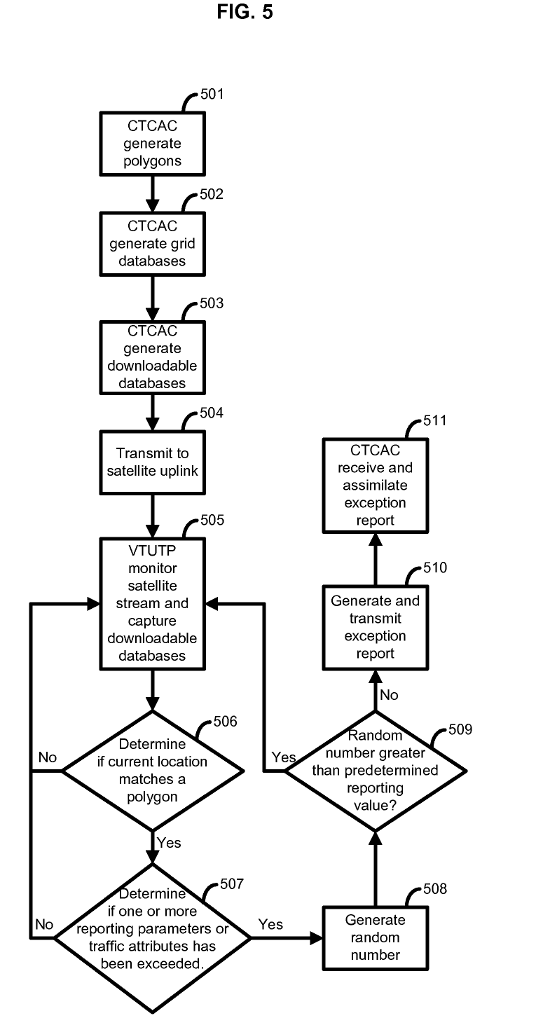

FIG. 5 illustrates an exemplary method of operation. At block 501, a CTCAC can generate polygons containing traffic areas of interest. At block 502, the CTCAC can process grid databases for each grid containing the polygons. At block 503, the CTCAC can store each grid database into a downloadable database. The downloadable databases can be titled with a five digit number, associated with the most southeast most coordinates. At block 504, the CTCAC can transmit the downloadable databases to a satellite uplink for transmission to one or more VTUTPs. At block 505, one or more VTUTPs monitors the satellite stream and captures the downloadable databases applicable to the VTUTP current location, and any adjacent downloadable databases applicable to areas adjacent to the VTUTP current location. At block 506, the VTUTP can compare the current location to entries in the downloadable databases to determine if the current location is within a polygon. If the current location is not within a polygon, the VTUTP returns to block 505 to monitor the satellite stream. If the current location is within a polygon, the VTUTP determine at block 507 whether one or more reporting parameters or traffic attributes have been exceeded. If one or more reporting parameters or traffic attributes have not been exceeded, the VTUTP returns to block 505 to monitor the satellite stream. If one or more reporting parameters or traffic attributes has been exceeded, the VTUTP can generate a random number at block 508. The random number can be compared to a predetermined reporting factor at block 509. The predetermined reporting factor can be between 0 and 100, for example, 5, 10, 15, 10, 25, 30, 35, 40, 45, 50, 55, 60, 65, 70, 75, 80, 85, 90, 95, 100, and the like. The predetermined reporting factor can be used to reduce the number of reports transmitted from VTUTPs within a given polygon by specifying a percentage. If the random number is greater than the predetermined reporting factor, the VTUTP returns to block 505 to monitor the satellite stream. If the random number is less than or equal to the predetermined reporting factor, the VTUTP can generate and transmit an exception report to the CTCAC at block 510. At block 511, the CTCAC can receive and assimilate the exception report.

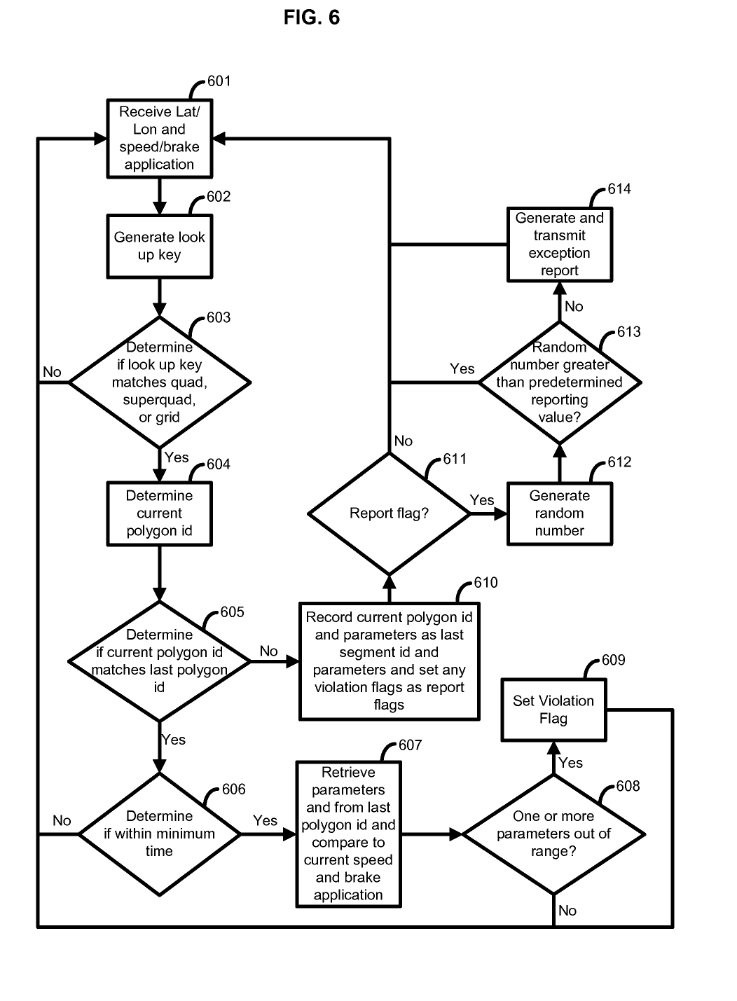

FIG. 6 illustrates another exemplary method of operation. At block 601 a VTUTP can receive the current latitude and longitude from a GPS, and current speed and brake application from a vehicle interface. For example, 33.90890 Lat 084.41264 Lon and 41 MPH, Brakes Applied. At block 602, the VTUTP can generate a lookup key based on the current latitude and longitude. For example, the look up key can comprise the first four digits of latitude and first four digits of longitude (0339008440000).

At block 603, the VTUTP can determine if the look up key corresponds to a quad, superquad, or grid stored in the VTUTP. If the lookup key does not correspond to a quad, superquad, or grid stored in the VTUTP, the VTUTP returns to block 601. If, at block 603, the look up key does correspond to a quad, superquad, or grid stored in the VTUTP proceeds to determine a current polygon id that contains the current latitude and longitude at block 604. Then, at block 605, the VTUTP can determine if the current polygon id corresponds to the last polygon id determined, if any. If the current polygon id does correspond to the last polygon id determined, the VTUTP proceeds to block 606 to determine if the VTUTP is operating within a predetermined minimum time (time factor) corresponding to reporting parameters for the current polygon. For example, the time factor can be in number between 0 and 100, for example, 5, 10, 15, 10, 25, 30, 35, 40, 45, 50, 55, 60, 65, 70, 75, 80, 85, 90, 95, 100, and the like.

If the VTUTP is not operating within the predetermined minimum time, the VTUTP returns to block 601. If the VTUTP is operating within the predetermined minimum time, the VTUTP retrieves the last polygon id parameters and compares the current speed and brake application to the retrieved parameters at block 607. A determination is made at block 608 as to whether any parameters are out of range. If no parameters are out of range, the VTUTP returns to block 601. If one or more parameters are out of range, the VTUTP sets a violation flag at block 609 and returns to block 601.

Returning to block 605, if the current polygon id does not correspond to the last polygon id determined, the VTUTP proceeds to block 610 and records the current polygon id and current polygon parameters as the last segment id and parameters. The VTUTP also sets any violation flags as report flags. At block 611, a determination can be made as to whether a report flag has been set. If a report flag has not been set, the VTUTP returns to block 601. If a report flag has been set, the VTUTP can generate a random number at block 612. The random number can be compared to a predetermined reporting factor at block 613. The predetermined reporting factor can be between 0 and 100, for example, 5, 10, 15, 10, 25, 30, 35, 40, 45, 50, 55, 60, 65, 70, 75, 80, 85, 90, 95, 100, and the like. The predetermined reporting factor can be used to reduce the number of reports transmitted from VTUTPs within a given polygon by specifying a percentage. If the random number is greater than the predetermined reporting factor, the VTUTP returns to block 601. If the random number is less than or equal to the predetermined reporting factor, the VTUTP can generate and transmit an exception report at block 614 then return to block 601.

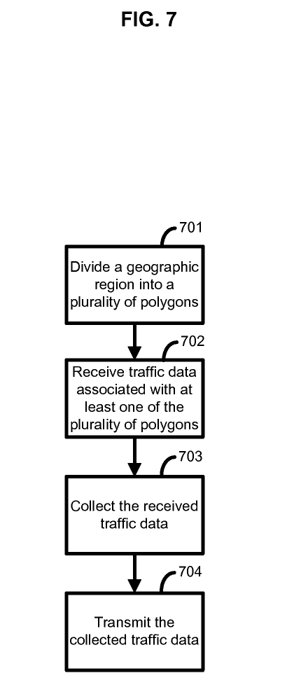

In another embodiment, illustrated in FIG. 7, provided are methods for automated traffic reporting comprising dividing a geographic region into a plurality of polygons at 701, receiving traffic data associated with at least one of the plurality of polygons wherein the traffic data is generated according to a reporting parameter at 702, collecting the received traffic data at 703, and transmitting the collected traffic data associated with the at least one of the plurality of polygons to a user located within the at least one of the plurality of polygons at 704.

The reporting parameter can comprise at least one of a predetermined time period, application of a vehicle braking system, failure to achieve a minimum speed, exceeding a maximum speed, and a random response. The reporting parameter can be determined dynamically.

The transmitted traffic data can be received via an onboard vehicle entertainment system. Transmission can be accomplished via a satellite digital audio radio service.

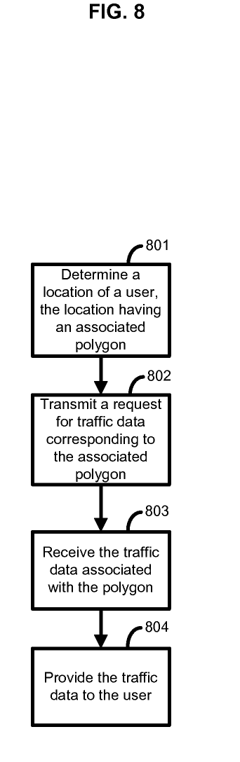

In another embodiment, illustrated in FIG. 8, provided are methods for automated traffic reporting comprising determining a location of a user at 801, the location having an associated polygon, transmitting a request for traffic data corresponding to the associated polygon at 802, receiving the traffic data associated with the polygon at 803, wherein the traffic data is generated according to a reporting parameter, and providing the traffic data to the user at 804.

The reporting parameter can comprise at least one of a predetermined time period, application of a vehicle braking system, failure to achieve a minimum speed, exceeding a maximum speed, and a random response. The reporting parameter can be determined dynamically.

Traffic data can be transmitted, received, and provided via an onboard vehicle entertainment system. Transmission and receipt can be accomplished via a satellite digital audio radio service.

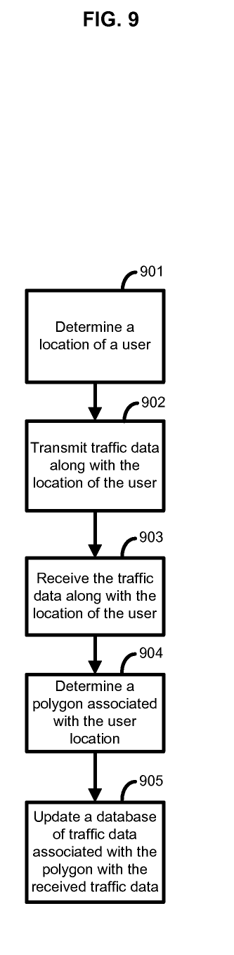

In a further embodiment, illustrated in FIG. 9, provided are methods for automated traffic reporting comprising determining a location of a user at 901, transmitting traffic data along with the location of the user at 902, wherein the traffic data is generated according to a reporting parameter, receiving the traffic data along with the location of the user at 903, determining a polygon associated with the user location at 904, and updating a database of traffic data associated with the polygon with the received traffic data at 905.

The reporting parameter can comprise at least one of a predetermined time period, application of a vehicle braking system, failure to achieve a minimum speed, exceeding a maximum speed, and a random response. The reporting parameter is determined dynamically.

Traffic data can be transmitted via an onboard vehicle entertainment system. Transmission can be accomplished via a satellite digital audio radio service.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification. It is intended that the specification and examples be considered as exemplary only, with a true scope and spirit being indicated by the following claims.

1. A method for automated traffic reporting comprising:
dividing a geographic region into a plurality of polygons;
receiving traffic data associated with at least one of the plurality of polygons; wherein the traffic data is generated according to a reporting parameter;
collecting the received traffic data; and
transmitting the collected traffic data associated with the at least one of the plurality of polygons to a user located within the at least one of the plurality of polygons.

2. The method of claim 1, wherein the reporting parameter comprises at least one of a predetermined time period, application of a vehicle braking system, failure to achieve a minimum speed, exceeding a maximum speed, and a random response.

3. The method of claim 1, wherein the transmitted traffic data is received via an onboard vehicle entertainment system.

4. The method of claim 3, wherein transmission is accomplished via a satellite digital audio radio service.

5. The method of claim 1, wherein the reporting parameter is determined dynamically.

6. A method for automated traffic reporting comprising:
determining a location of a user, the location having an associated polygon;
transmitting a request for traffic data corresponding to the associated polygon;
receiving the traffic data associated with the polygon, wherein the traffic data is generated according to a reporting parameter; and
providing the traffic data to the user.

7. The method of claim 6, wherein the reporting parameter comprises at least one of a predetermined time period, application of a vehicle braking system, failure to achieve a minimum speed, exceeding a maximum speed, and a random response.

8. The method of claim 6, wherein traffic data is transmitted, received, and provided via an onboard vehicle entertainment system.

9. The method of claim 8, wherein transmission and receipt is accomplished via a satellite digital audio radio service.

10. The method of claim 6, wherein the reporting parameter is determined dynamically.

11. A method for automated traffic reporting comprising:
determining a location of a user;
transmitting traffic data along with the location of the user, wherein the traffic data is generated according to a reporting parameter;
receiving the traffic data along with the location of the user;
determining a polygon associated with the user location; and
updating a database of traffic data associated with the polygon with the received traffic data.

12. The method of claim 11, wherein the reporting parameter comprises at least one of a predetermined time period, application of a vehicle braking system, failure to achieve a minimum speed, exceeding a maximum speed, and a random response.

13. The method of claim 11, wherein traffic data is transmitted via an onboard vehicle entertainment system.

14. The method of claim 13, wherein transmission is accomplished via a satellite digital audio radio service.

15. The method of claim 11, wherein the reporting parameter is determined dynamically.

16. An apparatus, located in a vehicle, for traffic reporting comprising:
a communications module configured to receive a polygon database wherein the polygon database comprises a reporting parameter describing a polygon;
a processor, coupled to the communications module, configured to generate a searchable database from the polygon database;
a memory, coupled to the processor, configured to store the searchable database;
a global positioning system (GPS), coupled to the processor, configured to determine the vehicle location;
a vehicle interface, coupled to the processor, configured to receive data indicative of vehicle performance; and
wherein the processor performs the steps of,
determining, based on the vehicle location determined by the GPS, if the vehicle is located within the polygon,
determining, based on data received from the vehicle interface, when the vehicle has exceeded the reporting parameter,
generating an exception, and
transmitting the exception to a central traffic assimilating center.

17. The apparatus of claim 16, wherein the communications module group comprises at least one of a satellite digital audio radio service, a cellular transceiver, a Wi-Fi transceiver, and a WIMAX transceiver.

18. The apparatus of claim 16, wherein the reporting parameter comprises at least one of a predetermined time period, application of a vehicle braking system, failure to achieve a minimum speed, exceeding a maximum speed,and a random response.

19. The apparatus of claim 16, wherein the vehicle interface comprises at least one of an OBD interface, an OBD-II interface, and a CAN interface.

20. The apparatus of claim 16, wherein the communications module further comprises an onboard vehicle entertainment system.
